(19) United States
(12) Patent Application Publication
(10) Pub. No.: US 2026/0223791 A1
(43) Pub. Date: Aug. 6, 2026

(54) Yard Sweeper

(71) Applicant: Jeff Gearhart, Monument, CO (US)

(72) Inventor: Jeff Gearhart, Monument, CO (US)

(21) Appl. No.: 19/042,992

(22) Filed: Jan. 31, 2025

(51) Int. Cl. A01G 20/43

(52) U.S. Cl. CPC A01G 20/43

(57) ABSTRACT

An apparatus includes a collecting end that collects the plurality of items on various surfaces. The apparatus can also include a bag connected to the collecting end. The bag is configured to collect the items on the various surfaces in multiple time intervals, wherein the bag works in conjunction with the collecting end to collect the items on the various surfaces in the multiple time intervals placing a tube at an initial position. The apparatus can also include a front end configured in front of the collecting and bag. The front end provides power to push the collecting end and bag to collect the items in the multiple time intervals.

### TECHNICAL FIELD

The present disclosure generally relates to a yard sweeping apparatus that uses a bag to dispose of trash obtained by the yard sweeping apparatus during operation.

### BACKGROUND

Current methods to collect trash and items when sweeping the yard and other surfaces can often result in inefficiency in cleaning. Many times, items have to be picked up manually. Other issues include having to manually sweep the items to another portion of the yard without having to efficiently and cleaning dispose of the items.

The time it takes to clean a yard can be considerably longer than it needs to be. When it is picked up by hand, or even it is swept across the yard by a manual pusher, the items have to be collected in a slow and methodical manner. The items also cannot be disposed off quickly and efficiently. The items can be dropped or spilled on various portions of the yard.

A need exists to reduce the time it takes to clean a yard of items such as leaves and sticks. The items in the yard need to be picked more efficiently without requiring the manual labor of hand work or of pushing it all to one side by a manual pushing machine.

A need also exits to be able to dispose of the items more efficiently. The items should not be dropped or re-spilled along various portions of the yard. A system is needed that can more efficiently clean the yard and more efficiently dispose of items that are collected during cleaning intervals.

### SUMMARY

The following summary is provided to facilitate an understanding of some of the features of the disclosed embodiments and is not intended to be a full description. A full appreciation of the various aspects of the embodiments disclosed herein can be gained by taking the specification, claims, drawings, and abstract as a whole.

The aforementioned aspects and other objectives can now be achieved as described herein.

In an embodiment, an apparatus includes a collecting end that collects the plurality of items on various surfaces. The apparatus can also include a bag connected to the collecting end. The bag is configured to collect the items on the various surfaces in multiple time intervals, wherein the bag works in conjunction with the collecting end to collect the items on the various surfaces in the multiple time intervals. Further, the apparatus can also include a front end configured in front of the collecting and bag. The front end provides power to push the collecting end and bag to collect the items in the multiple time intervals.

In an embodiment, a method includes positioning a collecting end that collects items on the various surfaces at initial end. The method can also include connecting a bag connected to the collecting end. The bag collects the items on the various surfaces in multiple time intervals, wherein the bag works in conjunction with the collecting end to collect the items on the various surfaces in the multiple time intervals. The method can also include placing a front end in front of the collecting end and bag. The front end provides power to push the collecting end and bag to collect the items in the multiple time intervals.

In an embodiment, a system includes a collecting end that collects items on various surfaces. The system can also include a bag connected to the collecting end. The bag is figured to collect the items on the various surfaces in multiple time intervals, wherein the bag works in conjunction with the collecting end to collect the items on the various surfaces in the multiple time intervals. The system can also include a front end configured in front of the collecting and bag. The front end provides power to push the collecting end and bag to collect the items in the multiple time intervals.

### BRIEF DESCRIPTION OF THE FIGURES

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates a side view of an apparatus in accordance with an embodiment of the invention;

FIG. 2 depicts a front view of the apparatus in accordance with an embodiment of the invention;

FIG. 3 illustrates a collecting bag clips in accordance with the invention; and

FIG. 4 illustrates another embodiment with two bags at a front of the apparatus in accordance with the invention;

Unless otherwise indicated illustrations in the figures are not necessarily drawn to scale.

### DETAILED DESCRIPTION OF SOME EMBODIMENTS

### Background and Context

The particular values and configurations discussed in these non-limiting examples can be varied and are cited merely to illustrate one or more embodiments and are not intended to limit the scope thereof.

Subject matter will now be described more fully herein after with reference to the accompanying drawings, which form a part hereof, and which show, by way of illustration, specific example embodiments. Subject matter may, however, be embodied in a variety of different form and, therefore, covered or claimed subject matter is intended to be construed as not being limited to any example embodiments set forth herein, example embodiments are provided merely to be illustrative. Likewise, a reasonably broad scope for claimed or covered subject matter is intended. Among other issues, subject matter may be embodied as methods, devices, components, or systems. The followed detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein may not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Generally, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as a “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

One having ordinary skill in the relevant art will readily recognize the subject matter disclosed herein can be practiced without one or more of the specific details or with other methods. In other instances, well-known structures or operations are not shown in detail to avoid obscuring certain aspects. This disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Unless defined otherwise, all technical and scientific terms used herein have the same meanings as commonly understood by one of ordinary skill in the art to which the disclosed embodiments belong. Preferred methods, techniques, devices, and materials are described, although any methods, techniques, devices, or materials similar or equivalent to those described herein may be used in the practice or testing of the present invention.

Although claims have been included in this application to specific enumerated combinations of features, it should be understood the scope of the present disclosure also includes any novel feature or any novel combination of features disclosed herein.

References "an embodiment," "example embodiment," "various embodiments," “some embodiments,” etc., may indicate that the embodiment(s) so described may include a particular feature, structure, or characteristic, but not every possible embodiment necessarily includes that particular feature, structure, or characteristic.

Headings provided are for convenience and are not to be taken as limiting the present disclosure in any way.

Each term utilized herein is to be given its broadest interpretation given the context in which that term is utilized.

### Terminology

The following paragraphs provide context for terms found in the present disclosure (including the claims):

The transitional term "comprising", which is synonymous with "including," "containing," or "characterized by," is inclusive or open-ended and does not exclude additional, unrecited elements or method steps. See, e.g., Mars Inc. v. H.J. Heinz Co., 377 F.3d 1369, 1376, 71 USPQ2d 1837, 1843 (Fed. Cir. 2004) ("[L]ike the term ‘comprising,’ the terms ‘containing’ and ‘mixture’ are open-ended."). "Configured to" or “operable for” is used to connote structure by indicating that the mechanisms/units/components include structure that performs the task or tasks during operation. "Configured to" may include adapting a manufacturing process to fabricate components that are adapted to implement or perform one or more tasks.

"Based On." As used herein, this term is used to describe factors that affect a determination without otherwise precluding other or additional factors that may affect that determination. More particularly, such a determination may be solely “based on” those factors or based, at least in part, on those factors.

All terms of example language (e.g., including, without limitation, “such as”, “like”, “for example”, “for instance”, “similar to”, etc.) are not exclusive of other examples and therefore mean "by way of example, and not limitation…".

A description of an embodiment having components in communication with each other does not infer that all enumerated components are needed.

A commercial implementation in accordance with the scope and spirit of the present disclosure may be configured according to the needs of the particular application, whereby any function of the teachings related to any described embodiment of the present invention may be suitably changed by those skilled in the art.

Further, any sequence of steps that may be described does not necessarily indicate a condition that the steps be performed in that order. Some steps may be performed simultaneously.

The functionality and/or the features of a particular component may be alternatively embodied by one or more other devices that are not explicitly described as having such functionality/features. Also, various embodiments of the present invention need not include a device itself.

More specifically, as will be appreciated by one skilled in the art, aspects of the present invention may be embodied as a system and/or method. Furthermore, aspects of the present invention may take the form of a plurality of systems to enable gas meter to perform self-checking to determine its overall functioning without requiring a meter operator.

### Introduction

Embodiments of the present invention include a yard sweeping device. The back end of the yard sweeping device can include a motor and other pulling mechanisms. The front end or collecting end of the device can include one or more collection bags that are attached to the collecting end for collection intervals of the yard and other various surfaces.

A single bag or multiple bags can be placed on the collecting end. The bags can stretch and be elastic. The bags can stretch as they are being collected by the items. The bags can remain secure on the collecting end without detaching from the collecting end. The user can decide the time and the number of collection intervals with the bags.

Once a collection interval is completed, the user can detach the bag or bags from the collecting end. The user can safely and efficiently dispose of the items such as the grass, leaves, and sticks, that have been collected. The items can be disposed of safely and efficiently without falling on the yard and repopulating the yard.

The user can replace the bag with another bag and perform more collection intervals. In other embodiments, the user can reuse the same bag as well. As such, the yard is more efficiently cleaned in a less amount of time, and the trash is disposed of more efficiently as well.

### System structure

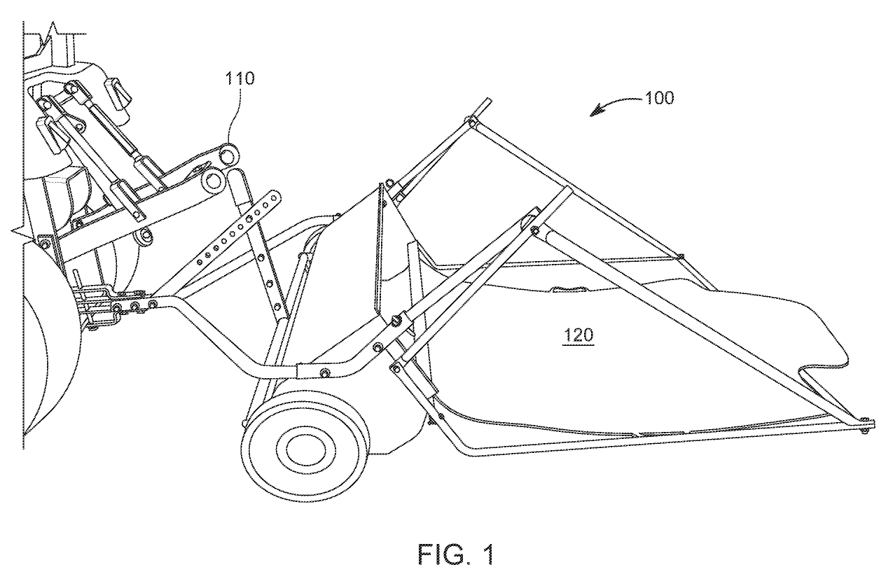

FIG. 1 illustrates an apparatus or device 100 for picking up leaves, grass, sticks, and other items that can typically be found on grass, ground, and other surfaces. The device 100 can include wheels and a motor. The front part of the device 100 can include a front end 110 that includes the motor and pushing mechanisms to push the device 100 on the various ground surfaces to pick the items on the various surfaces. The front end 110 can include the pushing mechanisms, the motor, the seat for the operator, and other materials that are typical of a motorized yard sweeping device. The front end 110 can provide structural support for the entire device 100. A collecting end 120 can be positioned adjacent to and in front of the front end 110.

In FIG. 1, in an embodiment, the collecting end 120 can include a sloped front portion that is designed to pick up the grass and leaves and other items found on the various surface. Further, in other embodiments, the collecting end 120 will include a bag that can be secured into the entire collecting end 120. Later figures will illustrate bags that can be attached to the collecting end 120 to collect the leaves, sticks, grass, and other items that can be picked off of the various surfaces.

With respect to FIG. 1, various time intervals, the front end 110 can work in conjunction with the collecting end 120 to push and collect trash and other items on the grass, ground, and other surfaces. The motorized portion of the front end 110 can provide the power to push the collecting end 120 forward. In the absence of a bag, the collecting end 120 can still push items away from an initial position to another position where the items can be disposed of.

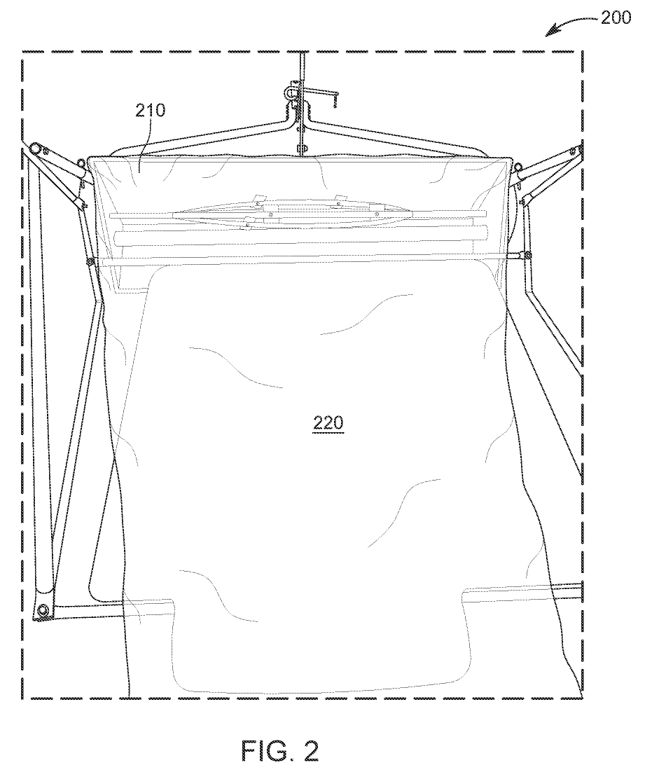

In FIG. 2, the yard sweeping device 200 is illustrated with the collecting end 210. Attached to the collecting end 210 is a bag 220. The bag 220 can be made from a variety of materials. The bag 220 can be stretchable and elastic and be able to bend in multiple time intervals. The bag 220 can be secured onto the collecting end 210 during collective intervals of items such as grass, leaves, sticks, and other items found on grass and ground surfaces.

Referring again to FIG. 2, the device 200 can have a motorized front end that pushes the collecting end 210 and bag 220 forward in multiple time intervals. The bag 220 can continuously pick up items on the various surfaces as the collecting end 210 and bag 220 are pushed forward in collection intervals. The bag 220 can remain secured onto the collecting end 210 during the collection intervals. The bag 220 can collect grass, leaves, sticks, and other items which the motorized front end travels over in conjunction with the collecting end 210 and bag 220. The bag 220 can remain elastic and stretchable throughout the collecting intervals. The direction of the collecting end 210 and bag 220 can also change in multiple intervals. The motorized front end can change directions on the various ground surfaces.

In FIG. 2, the bag 220 can continue to collect the various items until the bag is full and cannot collect any more items. At that interval in which the bag is full, the bag 220 can be detached form the collecting end 210 to dispose of the various collected items. In other intervals, the bag 220 can be reattached onto the collecting end 210 to proceed with additional collecting intervals. In other embodiments, an additional bag can replace the bag 220 to perform additional collecting intervals.

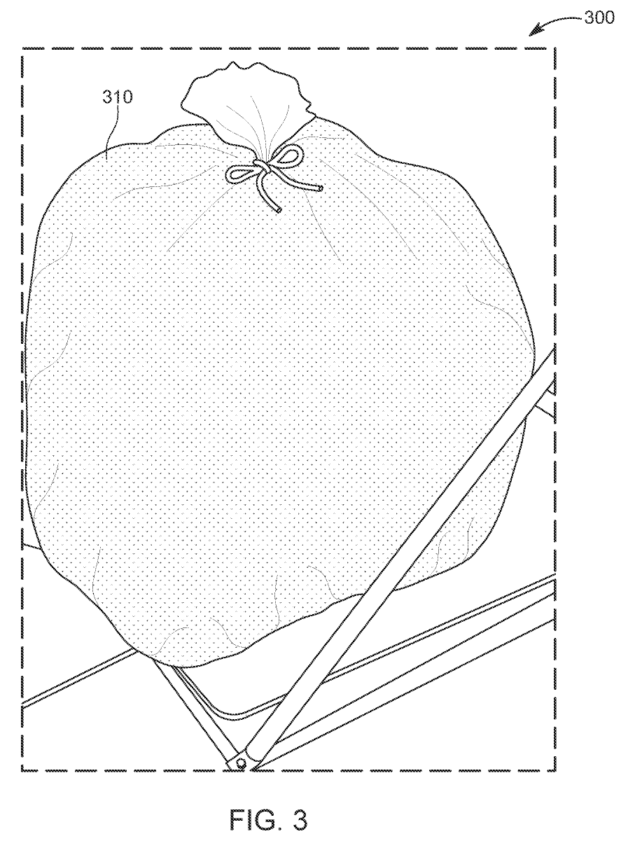

Referring to FIG. 3, the system 300 includes the bag 310 when it is detached from the collecting end and front end. The device can use the combined motorized front end and the collecting end with the bag 310 to collect leaves, sticks, grass, and other items on various surfaces. The device can be used in the forward and reverse directions. In some embodiments, the device can be used in sideways directions as well. The bag 310 can be secured onto the system 300 and the device during the collection intervals. The bag 310 can stretch elastically as it is collecting the items. The bag 310 can still remain sturdy and resist breaking during the collection intervals.

In FIG. 3, when the collecting intervals are finished, the bag 310 can be detached from the device. The user can dispose the items from the bag 310 into a waste containment or trash unit. In various embodiments, the bag 310 can be repositioned on the device. Further, in other embodiments, the bag 310 can be disposed of and replaced with another bag. In any embodiment, the bag 310 can remain elastic during collection intervals, and then be detached from the device. The user can dispose of the materials in a trash unit or the like without creating undue trash in various placed. The bag 310 can keep all of the collected items together during the collection intervals and then dispose of all of the items in the same trash unit. The bag 310 can ensure efficient collection and disposal of the items from the various surfaces.

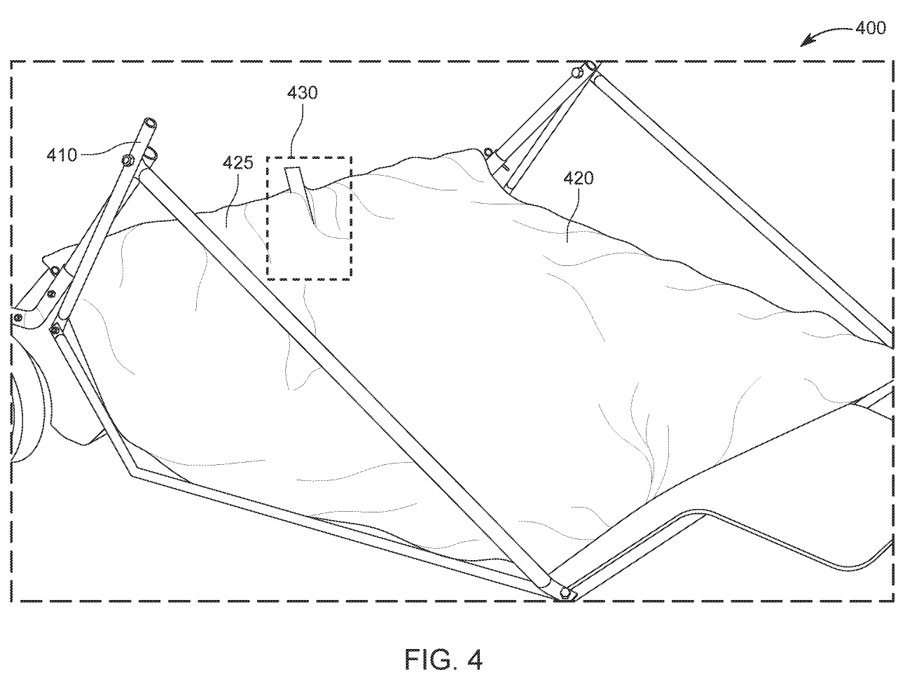

With respect to FIG. 4, a system 400 is illustrated in which the device 410 has two bags 420, 425 as opposed to a single bag in the earlier figures. An adaptor 430 is positioned between the bags 420, 425. The two bags 420, 425 can be safely secured onto the device 410 of the collecting end. The front end can include a motor to push the collecting end with the bags 420, 425. The bags 425 can be elastic and stretch to collect the various items from the surfaces in collection intervals. As such, the user can begin the collection interval by securing the bags 420, 425 on the device 410 at the collecting end. The front end with the motor can push the collective device 410 and bags 420, 425 forward and backward and in any direction necessary during collection intervals. The user can determine how many collection intervals are needed and how long each collection interval can be. The bags 420, 425 can collect each of the items on the various surfaces in each collection interval.

Referring again to FIG. 4, the bags 420, 425 can then be detached form the system 400 with the collected items. During the collection intervals, the bags 420, 425 can stretch in relation to the collected items. When the bags 420, 425 are detached from the system 400, the bags 420, 425 can be safely tied as shown in FIG. 3. The bags 420, 425 can then be untied when necessary to dispose of the items. The bags 420, 425 can keep the collected items secured during the collection intervals. During the disposal intervals, the bags 420, 425 can safely dispose of the items in a single trash unit without creating undo untidiness or mess in the surrounding area.

### SUMMARY/ADVANTAGES

Overall, the yard sweeper has a front end that is motorized and a collecting end that has a bag or multiple bags to collect items on the grass, and other various surfaces that have items to be collected. The bag or bags can be safely secured onto the collecting end before the collection intervals. The front end with the motor can push the collecting end and bags forward and backward or in any necessary direction to collect the items on the various surfaces.

The bag or bags can stretch in relation to the collected items. The bags will not break or detach from the collecting end. During the collection intervals, the bags will stretch as it collects the leaves, sticks, grass and other materials on the ground. The bag or bags will stretch to a maximum limit before having to be either replaced, or temporarily removed from the collecting end to dispose of the collected items.

During the disposal intervals, the bag or bags can have all of the collected items secured. As such, the bag can be opened at the top to dispose of the items in a trash unit or the like. The collected items can be safely disposed without creating undo untidiness of the collected items being spread out over the collection area.

The system, with the bags, can collect more items successfully in a lesser amount of time. The items can also be secured within the bags without being spread over various areas in the collection area during collection interval. The efficiency of collecting a large amount of the items can be done in less time than in other collection systems. The bags have elasticity to stretch with the items during the collection items. The items can all be disposed off at once in a same trash unit without being accidentally spread out over the collection area. The efficiency of the collection time can be improved due to the amount of items that can be collected at once. The collection area can be kept clean and be easier to clean because the collected items can be secured in the bag without spilling out, and then be disposed of securely in a single trash unit or the like.

### Conclusion

All references, including granted patents and patent application publications, referred herein are incorporated herein by reference in their entirety.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Various aspects of the invention have been described above by way of illustration, and the specific embodiments disclosed are not intended to limit the invention to the particular forms disclosed. The particular implementation of the system provided thereof may vary depending upon the particular context or application. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

The corresponding structures, materials, acts, and equivalents of all means or step plus function elements in the claims below are intended to include any structure, material, or act for performing the function in combination with other claimed elements as specifically claimed.

1. An apparatus for picking up a plurality of items, the apparatus comprising:
a collecting end that collects the plurality of items on various surfaces;
a bag connected to the collecting end, wherein the bag is configured to collect the items on the various surfaces in multiple time intervals, wherein the bag works in conjunction with the collecting end to collect the items on the various surfaces in the multiple time intervals; and
a front end configured in front of the collecting and bag, wherein the front end provides power to push the collecting end and bag to collect the items in the multiple time intervals.

2. The apparatus of claim 1, wherein the front end pushes the collecting end
and bag forward in the multiple time intervals.

3. The apparatus of claim 1, wherein the bag is detachable from the collecting end.

4. The apparatus of claim 1, wherein the bag is secured onto the collected end when collecting the items on the various surfaces.

5. The apparatus of claim 1, wherein the bag is repositioned onto the collecting end after disposing the items collected from the various surfaces.

6. The apparatus of claim 1, wherein the bag is detached from the collecting end to dispose the items collected from the various surfaces.

7. The apparatus of claim 1, wherein the collecting end and bag are pulled in the forward direction to collect the items from the various surfaces.

8. A method for collecting items on various surfaces, the method comprising:
positioning a collecting end that collects the items on the various surfaces at initial end;
connecting a bag connected to the collecting end, wherein the bag collects the items on the various surfaces in multiple time intervals, wherein the bag works in conjunction with the collecting end to collect the items on the various surfaces in the multiple time intervals; and
placing a front end in front of the collecting end and bag, wherein the front end provides power to push the collecting end and bag to collect the items in the multiple time intervals.

9. The method of claim 8, further comprising:
positioning a motor within the front end to push the collecting end and bag in multiple intervals.

10. The method of claim 8, further comprising:
pushing the bag and collecting end forward in multiple intervals to collect the times on the various surfaces.

11. The method of claim 8, further comprising:
detaching the bag from the collecting end in multiple time intervals to dispose of the items collected from the various surfaces.

12. The method of claim 8, further comprising:
identifying when the bag should be detached from the collecting end in multiple time intervals.

13. The method of claim 8, wherein the items include various leaves, grass, and sticks positioned on the various surfaces.

14. The method of claim 8, further comprising:
positioning an additional bag at the collecting end in a set time interval.

15. A system for picking up a plurality of items on various surfaces, the system comprising:
a collecting end that collects items on various surfaces;
a bag connected to the collecting end, wherein the bag is figured to collect the items on the various surfaces in multiple time intervals, wherein the bag works in conjunction with the collecting end to collect the items on the various surfaces in the multiple time intervals; and
a front end configured in front of the collecting and bag, wherein the front end provides power to push the collecting end and bag to collect the items in the multiple time intervals.

16. The system of claim 15, the bag is removed and replaced with another bag at a set interval.

17. The system of claim 15, further comprising:
a pushing mechanism positioned in front of the collecting end and bag.

18. The system of claim 17, wherein the motor pushes the collecting end and bag in a forward direction in multiple intervals.

19. The system of claim 15, wherein the bag is configured to collect at least one of grass, sticks, and rocks in multiple intervals.

20. The system of claim 15, where the bag is secured onto the collecting end, and detachable from the collecting end to dispose of the items collected.
